(19) United States
(12) Patent Application Publication
(10) Pub. No.: US 2026/0104132 A1
(43) Pub. Date: Apr. 16, 2026

(54) Multi Axis Tripod Mount with Ball Joint

(71) Applicants: Drew Miles, II, El Cajon, CA (US); Paul Tarpy, Santee, CA (US); Broc Kelly, El Cajon, CA (US)

(72) Inventors: Drew Miles, II, El Cajon, CA (US); Paul Tarpy, Santee, CA (US); Broc Kelly, El Cajon, CA (US)

(21) Appl. No.: 19/358,279

(22) Filed: Oct. 14, 2025

Related U.S. Application Data
(60) Provisional application No. 63/706,716, filed on Oct. 13, 2024.

(51) Int. Cl. F16M 11/20; F16C 11/06

(52) U.S. Cl. CPC F16M 11/2078; F16C 11/0623; F16M 2200/022

(57) ABSTRACT

A multi axis tripod mount is configured for coupling a camera or instrument needing elevated support to the top of or to a platform atop a tripod. The tripod mount provides rotational movement to the camera engaged thereto along a horizontal access by rotation of a first bearing connector upon a mount therefor. Vertical rotation along a vertical axis is provided to the camera so engaged by rotation of a second bearing component of the mount upon a second bearing mount. Rotation along a variable ball access to the mounted camera is provided by rotating a ball engaged having a ball member supporting the camera connecter engaging the camera. The tripod mount thus provided concurrent movement along three different axis to a camera or instrument engaged.

This application claims priority to U.S. Provisional Patent Application Ser. No. 63/706,716 filed on Oct. 13, 2024.

### BACKGROUND OF THE INVENTION

### 1. Field of the Invention

The present invention relates to mounts for cameras and surveying equipment and the like. More particularly, it relates to a platform formed as part of or which is positionable atop a tripod, wherein the platform is rotatable along a horizontal axis, a vertical axis and a ball positioned in a ball mount provides adjustment along a third, or ball, axis.

### 2. Prior Art

In photography and surveying and other endeavors requiring support of a measuring or viewing component, the tripod is a widely used portable device to provide an adjustable yet highly stable support for cameras and other instruments operatively engaged to the platform upon the tripod.

Conventionally, almost all photographic tripods have three legs which extend to a mounting head, or platform, atop rotating engagement of the three legs to the tripod. The conventional mounting head has a shoe, or other fixture, which is configured to removably couple the instrument or camera requiring such an elevated and stable support to the mounting head.

The mounting head itself can include components to provide a horizontal axis adjustment, and in some cases a vertical axis adjustment to allow an adjustment of the pointing of the camera lens or a measuring instrument lens to various inclined angles and points around the mounting head. Such mounting heads, thus, provide the user the ability to engage the camera or instrument to the platform or mounting head and to subsequently adjust the direction of view of the camera around a horizontal plane surrounding the tripod, as well as along a vertical plane running above and below the tripod.

The forgoing examples of related art and limitations related therewith, as to tripods and the engagement thereof to cameras and instruments requiring a stable mount, are intended to be illustrative and not exclusive, and they do not imply any limitations on the multi axis tripod device herein. Various limitations of the related art will become apparent to those skilled in the art upon a reading and understanding of the specification below and the accompanying drawings.

### SUMMARY OF THE INVENTION

The device herein disclosed and described provides a significant enhancement to the utility of conventional tripod mounts and platforms which engage cameras and the like. The device herein is configured to be part of or to couple to a conventional tripod. Such an operative coupling may be with a quick release platform employed atop tripods to hold a camera or measuring instrument steady, and at a user-chosen fixed position. Alternatively, such conventional tripods may have a connector for engaging a camera or component directly, or engaging a quick release component which is adapted to engage and release to the camera or instrument to be mounted. The device herein is thus configured for operative coupling to the tripod to provide the mounting platform or to the tripod platform to provide three axis adjustability.

The device herein includes a mounting platform having a ball mount. As noted, the mounting platform of the device herein, which may be coupled atop to the mounting platform, conventionally positioned atop the legs of a tripod or similar support for cameras and measuring instruments, such as survey lens instruments or lasers and the like, which require a fixed positioning during use. The coupling of the mounting platform of the device herein to the tripod platform is accomplished using a conventional connector. Such conventional connectors on many tripod platforms may be a thumb screw which engages into a threaded passage, or a connection of a quick release component to the tripod platform which is adapted to engage and disengage easily from the camera or precision instrument being mounted to the tripod.

The mounting platform has a first axis adjustment component, such as a first bearing mount, which allows for rotation of a camera or instrument mount located on the mounting platform in directions surrounding or encircling the first or horizontal axis adjustment component. In the device herein, such is provided by a first bearing component engaged to a first bearing mount wherein the first bearing component will rotate upon the first bearing mount to various directions along a first or horizontal axis around a horizontal plane surrounding the tripod.

To this first bearing mount which adjusts along the horizontal plane or axis is coupled a second bearing mount having a second bearing component rotationally engaged to the second bearing mount. This second bearing mount provides rotational adjustment of an engaged camera or instrument in the vertical plane or along a vertical axis running substantially normal to the horizontal plane of the first bearing mount.

Rotationally engaged to the second bearing mount is coupled a ball mount. This ball mount is configured for operative engagement to a camera or instrument, such as with a mounting adapted for quick release plate or similar conventional removable coupling device to engage a camera to a tripod. Alternatively, a thumb screw type mount, or other connector, may be employed for a coupling between the ball mount and the camera and instrument thereon.

The ball mount is adjustably coupled in a ball mount to allow the user to vary the positioning of a ball member and a pointing of the camera or measuring device or the like along a third axis to chosen angles which positions or aims the lens of the camera or instrument along a line which is not perpendicular to the horizontal axis or plane. This ball adjustment thereby allows the user to maintain the vertical axis running through the camera or instrument parallel to the vertical axis and maintain a horizontal axis, and to adjust the ball to run the ball member axis through the camera to angles relative to the vertical axis. This provides significant utility to the user since the device allows for perpendicular positioning and angled positioning of the axis of a lens or measuring instrument component relative to the vertical axis.

With respect to the above description, before explaining at least one preferred embodiment of the herein disclosed multi axis mount will ball joint connection to a camera, it is to be understood that the invention is not limited in its application to the details of construction and to the arrangement of the components in the following description or illustrated in the drawings.

The invention herein which discloses current preferred modes thereof, after testing and design, is capable of other embodiments and of being practiced and carried out in equivalent ways which may be discerned by those skilled in the art upon review of this disclosure. Also, it is to be understood that the phraseology and terminology employed herein are for the purpose of description and should not be regarded as limiting.

As such, those skilled in the art will appreciate that the conception upon which this disclosure is based, may readily be utilized by those skilled in the art subsequent to review of this specification, as a basis for the design of other configurations of the tripod mount with ball joint engagement herein, and for carrying out the several purposes of the present disclosed device. It is important, therefore, that the claims be regarded as including the equivalent devices and equivalent construction and methodology therefor insofar as they do not depart from the spirit and scope of the present invention.

As used in the claims to describe the various inventive aspects and embodiments, “comprising” means including, but not limited to, whatever follows the word “comprising.” Thus, use of the term “comprising” indicates that the listed elements are required or mandatory, but that other elements are optional and may or may not be present. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. Finally, unless provided with a different respective definition, the term substantially herein means plus or minus five percent.

It is an object of this invention to provide a ball joint coupling of a camera or measuring instrument or the like to a conventional tripod platform, which allows the user to vary the angle of the axis of the lens of the instrument or camera relative to the vertical axis and horizontal axis of the adjustable platform.

It is a further object of the invention to provide an adjustable mount to a tripod, or as an integral part of a tripod, which provides a two way pan head having a ball mount positioned thereon.

These and other objects of the ball joint engagement for cameras and instruments to a multi-axis tripod platform invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the tripod mounting device herein. It is intended that the embodiments and figures disclosed herein to be considered illustrative rather than limiting.

In the drawings:

FIG. 1 depicts a platform which is positionable at the engagement point of the legs of a tripod, or the like, to a tripod showing the adjustability along and around a horizontal axis and along and around a vertical axis and showing the ball joint mount having a connecting member for engaging the camera or instrument to adjust also along a ball member axis.

FIG. 2 is a side view of the device of FIG. 1 showing the ball mount having a the ball member extending therefrom along a ball member axis and which is adapted to couple to a camera or instrument being supported by the tripod or be included as the platform for the tripod.

FIG. 3 shows the adjustability of the ball mount in a connection to the second bearing component to change the angle of the ball mount along the vertical axis, and to change the angle of the ball member axis and thus the angle of the axis of the coupled camera lens or instrument to various non parallel angles relative to the vertical axis.

FIG. 4 shows an overhead view of the device herein showing the ball mount coupled to the second bearing component and having the ball member extending therefrom and the adjustability of the ball member axis provided by rotation of the ball.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right, and other such terms refer to the disclosed tripod coupling device for a camera or instrument as it is oriented and appears in the drawings and are used for convenience only. The language is not intended to be limiting or to imply that the tripod mounting device herein or components thereto have to be used or positioned in any particular orientation.

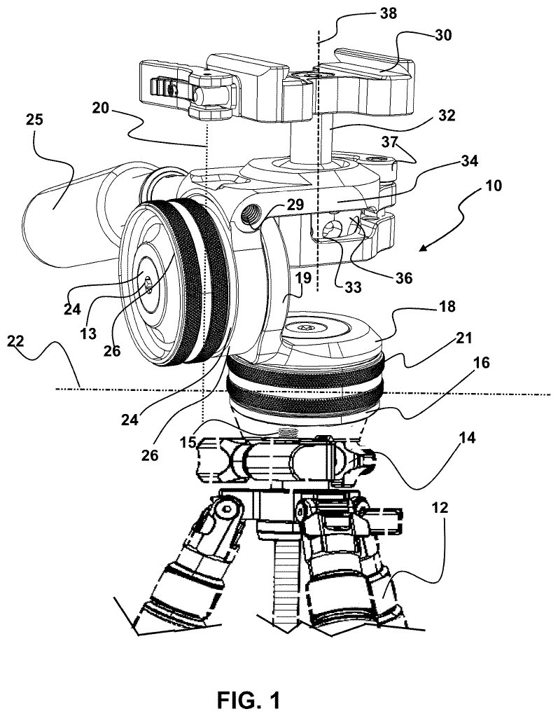

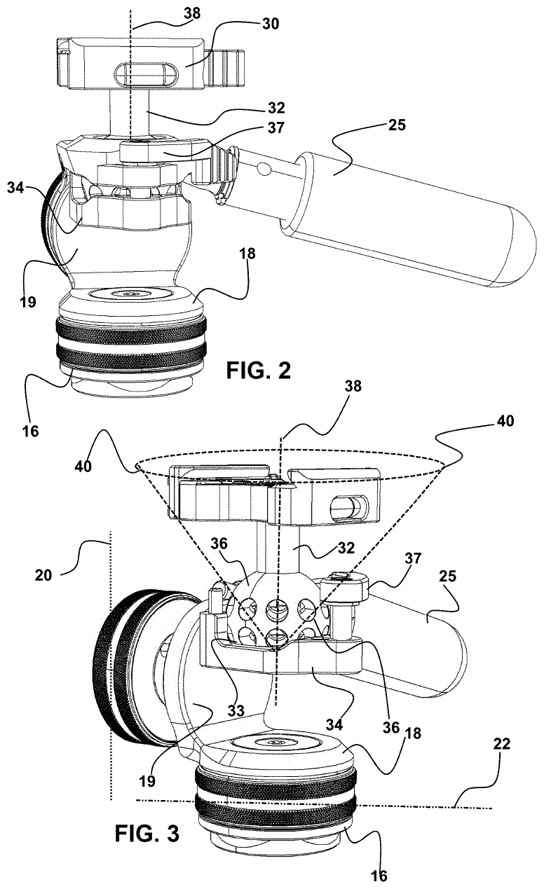

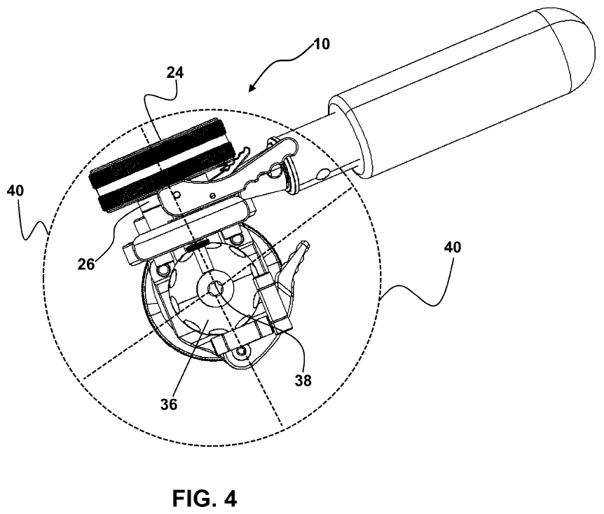

Now referring to drawings in FIGS. 1-4, wherein similar components are identified by like reference numerals, there is seen in FIG. 1 the device 10 in operative positioning atop a tripod or similar support. Such conventional tripods and the like include a tripod platform 14 which is operatively connected to the legs of the tripod 12 where the legs may be rotationally engaged thereto in the conventional fashion.

The device 10 is configured to operatively couple to the tripod platform 14 of a conventional tripod. By operatively couple is meant that the device 10 has connectors which are configured to removably couple to the tripod platform 14, such as a thumb screw 15 on the tripod platform 14, which engages with a mating cavity 13 on the first bearing connector 18 or second bearing mount 24, or a quick connect fitting on the tripod platform 14 which mates with a mating quick connect fitting coupled to the first bearing connector 18 or second bearing mount 24, or another connection means adapted to operatively couple the device 10 to a tripod platform 14.

The first bearing mount 16 which is configured for engagement to a tripod platform 14. The first bearing connector 18 is rotationally coupled to the first bearing mount 16 and rotates in a first rotational direction upon a first bearing 21 coupled with between the first bearing mount 16 and the first bearing connector 18. This first rotational direction provides for rotation of the connector 30 of the device 10, which as noted herein is configured to couple with a camera or other instrument to be held elevated by the tripod 12, around a horizontal axis 22. The connector 30 may be any connector 30 which is configured to couple to a camera or other instrument to be held atop a tripod 12 by the device 10 herein. While in no way limiting the depicted connector 30 is shown as a conventional quick connector coupled to the ball member 32 which is configured to quickly connect to a mating connector component coupled to the camera or instrument. Any connector which couples to the ball member 32 and will couple with a camera or instrument to be held by the device 10 may be employed.

Also shown in FIGS. 1-4 are a second bearing mount 24 is rotationally coupled with the second bearing component 26. The second bearing component rotates upon the second bearing mount 24 in the direction of the vertical axis 20. The second bearing mount 24 is coupled to the first bearing connector 18 at an extension 19 which is coupled to or is a part of the first bearing connector 18 and extends therefrom. Preferably, the axis of the extension 19 runs perpendicular to the horizontal axis 22 and runs parallel to the vertical axis 20 along which the second bearing component 26 rotates. The rotation of the second bearing component 26 allows for adjustment of the height of the vertical axis 20 of the device 10 and will thus adjust the vertical axis 20 communicated to any camera or instrument coupled to this second bearing component 26 and the angle of the lens of the camera along that vertical axis 20.

A brake to hold the second bearing component 26 in position around the vertical axis 20 may be provided. For example, and in no way limiting, the handle 25 can be employed to fix the position of the second bearing component 26 by rotating the handle 25 to compress the second bearing component 26 in its rotating coupling to the second bearing mount 24. Rotating the handle 25 rotates a threaded portion at the distal end thereof which is engaged with a threaded cavity 29 to slightly compress the second bearing component 26 upon the second bearing mount 24 to hold position thereon. Of course, other means to brake the motion of the second bearing component can be employed.

In the device 10 herein, as noted, the coupling of the camera or instrument to the device 10 is provided by a connector 30, such as a quick connect. The connector 30 is configured to couple the camera or instrument to the distal end of a ball member 32 extending from a ball mount 34 which is coupled to the second bearing component 26 which, as noted, will rotate along the vertical axis 20 upon the second bearing mount 24.

The ball mount 34 includes a ball 36 which is rotationally coupled within an interior cavity 33 of the ball mount 34. The ball mount 34 is coupled to the rotatable second bearing component 26 to allow rotation along the vertical axis 20 of the ball mount 34. Because the ball 26 is rotatable in this engagement in the interior cavity 33 within the ball mount 34 the rotation of the ball 36, will adjust an angle of the ball member 32 along a ball member axis 38. The ball 26 may be in a tight rotational coupling within the interior cavity 33 of the ball mount 34 to hold position when not forced or as shown a ball lock 37 may define a releasable ball brake. The ball lock 37 part of a surface of a handle which may be rotated to contact against the ball 36 and hold the position thereof.

This adjustment of the ball 36 will tilt any camera or instrument coupled to the ball member 32 along with changing the ball member axis 38. The maximum angle of adjustment 40 of the ball member axis 38 is determined by how far the ball 36 will rotate in the interior cavity 33 within ball mount 34 connected to the second bearing component 26. A ball lock 37 if included allows for fixing the position of the ball 36 in the ball mount 34 to thereby fix the ball member axis 38.

As can be discerned, the device 10, as shown herein, allows for adjustment of the engaged camera or instrument, along the horizontal axis 22, along the vertical axis 20, and along a ball member axis 38. Three axis of adjustment provide the user an ability to change the angle of a mounted camera or instrument to virtually an infinite number of angles.

While all of the fundamental characteristics and features of the tripod mounting device having a ball joint connection thereof to a camera or instrument have been shown and described herein, with reference to particular embodiments thereof, a latitude of modification, various changes, and substitutions are intended in the foregoing disclosure and it will be apparent that in some instances, some features of the invention may be employed without a corresponding use of other features of the invention without departing from the scope of the invention as set forth. It should also be understood that various substitutions of components for equivalent components and modifications variations may be made by those skilled in the art without departing from the spirit of the invention and such are intended to be included in the claims that follow.

What is claimed is:

1. A multi axis tripod mount for coupling a camera or instrument to a tripod, comprising:
a first bearing mount configured for coupling to a tripod platform atop a tripod;
a first bearing connector rotationally coupled with said first bearing mount, said first bearing connector rotatable along a horizontal axis;
a connector coupled to said first bearing mount and extending substantially perpendicular to said horizontal axis;
a second bearing component rotationally coupled to a second bearing mount extending from said connector;
said second bearing component rotatable along a vertical axis perpendicular to said horizontal axis;
a ball mount coupled to said second bearing component, said ball mount having an interior cavity;
a ball rotatably positioned within said interior cavity, said ball having a ball member engaged at a first end thereof and extending to a second end;
a connector coupled to said second end of said ball member, said connector for engaging with a camera or instrument; and
said ball member having a ball axis running therethrough, said ball axis being adjustable by rotation of said ball within said interior cavity, whereby a said camera coupled to said connector is rotatable along said horizontal axis and said vertical axis and said ball axis to adjust a positioning thereof.

2. The multi axis tripod mount for coupling a camera or instrument to a tripod of claim 1 additionally comprising:
a brake lever coupled to said ball mount; and
said brake lever positionable to a contact of a surface thereon with said ball, said contact of said surface defining a brake to hold said ball in position whereby said ball axis may be fixed by positioning said brake to said contact with said ball.

3. The multi axis tripod mount for coupling a camera or instrument to a tripod of claim 1 additionally comprising:
a brake for holding said second bearing component in a fixed position around the vertical axis.

4. The multi axis tripod mount for coupling a camera or instrument to a tripod of claim 2 additionally comprising:
a brake for holding said second bearing component in a fixed position around the vertical axis.

5. The multi axis tripod mount for coupling a camera or instrument to a tripod of claim 3 wherein said brake comprises:
said second bearing component being compressible upon second bearing mount;
a threaded portion at a distal end of said handle coupled with a threaded cavity on a section of said second bearing component; and
rotation of said handle in one direction imparting movement of said section to a compressive contact with said bearing mount.

6. The multi axis tripod mount for coupling a camera or instrument to a tripod of claim 4 wherein said brake comprises:
said second bearing component being compressible upon second bearing mount;
a threaded portion at a distal end of said handle coupled with a threaded cavity on a section of said second bearing component; and
rotation of said handle in one direction imparting movement of said section to a compressive contact with said bearing mount.

7. A multi axis tripod mount for coupling a camera or instrument to a tripod of claim 1, comprising:
a tripod having three legs; and
said first bearing forming said tripod platform.
